(19) United States
(12) Patent Application Publication
(10) Pub. No.: US 2025/0148924 A1
(43) Pub. Date: May 8, 2025

(54) Electronic Flight Strip System

(71) Applicant: Skyverse Limited, London (GB)

(72) Inventors: Michael Andrew Bramworth, London (GB); John Mark McLoughlin, London (GB); Jacob Hal Newberry, London (GB); Andrew Michael Belshaw, London (GB)

(73) Assignee: Skyverse Limited, London (GB)

(21) Appl. No.: 19/018,775

(22) Filed: Jan. 13, 2025

Related U.S. Application Data
(63) Continuation of application No. PCT/GB2023/051821, filed on Jul. 11, 2023.

(30) Foreign Application Priority Data
Jul. 13, 2022 (GB) 2210293.3

(51) Int. Cl. G08G 5/72; G08G 5/23; G08G 5/30

(52) U.S. Cl. CPC G08G 5/72; G08G 5/23; G08G 5/30

(57) ABSTRACT

Disclosed herein is a computer implemented method for providing an electronic flight strip system over a network, the method comprising: receiving and authenticating a remote user login request; identifying a pre-configured electronic flight strip system instantiation associated with the remote user; and, serving the pre-configured electronic flight strip system instantiation for display and user interaction on a remote display for managing aircraft movements using electronic flight strips on a digital flight board.

### BACKGROUND

Flight strips (also known as flight progress strips) have been used for Air Traffic Services and information distribution for decades to track the location and status of aircraft at, and in the vicinity of, aerodromes.

Traditional flight strips are represented by physical paper strips, each of which is associated with a unique flight or aircraft. These flight strips are normally positioned on a flight progress board that has different bays representing either the physical location of an aircraft on the ground or in the air around an aerodrome or a phase of flight. The flight strip is moved between different bays on the board as the position of the aircraft, or phase, changes. For example, one bay on the board may represent Pending Departures at the Apron, or the Runway.

As the flight progresses, Air Traffic Controllers (or other Air Traffic Service operational staff, such as Flight Information Service Officers) annotate the physical strips with information such as Estimated Departure Time, Runway and Route. New information is regularly added to each flight strip as the flight status progresses, but information is generally never erased. These flight strips act as a legal record of flight progress, and their accuracy is paramount in ensuring safe flight operations in the vicinity of aerodromes.

Some larger aerodromes (such as major international airports) have moved to electronic flight strip systems which display digital versions of paper flight strips on a computer screen or similar. As with paper flight strips, these electronic flight strips display information for Air Traffic Services associated with a flight, and this information persists on the display as long as the electronic flight strip remains active.

### SUMMARY OF THE INVENTION

According to a first aspect of the invention, there is provided a computer implemented method for providing an electronic flight strip system over a network, the method comprising: receiving and authenticating a remote user login request; identifying a pre-configured electronic flight strip system instantiation associated with the remote user; and, serving the pre-configured electronic flight strip system instantiation for display and user interaction on a remote display for managing aircraft movements using electronic flight strips on a digital flight board.

The invention allows for a cloud-based electronic flight strip system which can be customised according to aerodrome preferences. Features such as flight progress board layouts can be stored such that the electronic flight strip system instantiation served to the remote display is specific to the requirements of the aerodrome and/or individual Air Traffic Controllers. Existing systems are generally hosted on the aerodrome premises without the need for user authentication (i.e., a single instantiation of an electronic flight strip system may be shared between multiple users), so the invention also allows for improved connectivity, access security and auditing.

In addition, setting up and maintaining an on-premises local server to host an electronic flight strip system is expensive and time-consuming. This is particularly disadvantageous for smaller regional airports and local aerodromes, which may not have the capital or resources for such an investment. By hosting the electronic flight strip system remotely, a new aerodrome can be set up more rapidly and at lower cost. Rather than having to wait for a local server to be installed on premises (which could take many weeks or months), an aerodrome operator can begin configuring and operating an electronic flight strip system straight away. This results in lower installation, maintenance and setup costs.

Furthermore, providing a remotely-hosted instantiation of the electronic flight strip system provides increased resilience and non-repudiation. For example, the remotely-hosted instantiation can act as a remote backup to an electronic flight strip instantiation hosted locally on the remote user's device. If the locally-hosted instantiation is corrupted, or unauthorised modifications are made to an electronic flight strip (either inadvertently or maliciously), the remote instantiation can be loaded to restore the correct electronic flight strips.

Optionally, the pre-configured electronic flight strip system instantiation is configured by: serving an initial electronic flight strip system template for display and user interaction through an aerodrome configurator interface; modifying one or more parameters of the electronic flight strip system template in response to user input received through the configurator interface to create an electronic flight strip system configuration which defines a flight board divided into a number of bays, each bay being associated with a respective type of aircraft location, and electronic flight strips having data fields which are determined and populated according to which bay the electronic flight strip is located; and, saving the electronic flight strip system configuration as the pre-configured electronic flight strip system instantiation for subsequent use by the remote user.

Existing electronic flight strip systems are generally bespoke, built from the ground up for a particular aerodrome. Changes to the system can only be made by specialist engineers, who must directly access and modify the underlying computer code. This results in high installation, maintenance and alteration costs. Providing an initial electronic flight strip system template for user interaction through an aerodrome configurator further simplifies the process of setting up a new aerodrome. Rather than starting from scratch, a customer is provided with an initial template and an interface for modifying the template. The customer can create a customised configuration for their aerodrome.

The flight boards defined by the electronic flight board configuration simplify the workload for the Air Traffic Controllers who will operate the electronic flight strip system. Much like traditional paper flight strips, existing electronic flight strips typically display information for Air Traffic Services associated with a flight, and this information persists on the display as long as the electronic flight strip remains active. Consequently, some of the information presented to the Air Traffic Controller is irrelevant to the current state of the flight (for example, the Calculated Take-off Time (CTOT) is not particularly important to an Air Traffic Controller once a flight becomes airborne).

In contrast, the flight boards of the electronic flight strip configuration cause electronic flight strips to display different fields based on the aircraft location, which in the present application may refer to either a physical location of an aircraft (e.g., the runway) and/or to the aircraft's phase of flight (e.g., pending departures or pending arrivals). For example, an electronic flight strip placed in a bay of the display area representing the Taxiway may display a Calculated Take-off Time, Clearance Limit, Runway, Route, Level and Destination. Once the aircraft enters the Runway, the Air Traffic Controller may use a user input to indicate that the electronic flight strip should move to a bay of the display representing the Runway. The fields of the electronic flight strip may then display, for example, an Actual Time of Departure, Clearance Limit, Runway, Route, Level and Destination.

By displaying different fields based on the aircraft location, the amount of data presented to the Air Traffic Controller can be reduced, making it easier and quicker for the Air Traffic Controller to read the electronic flight strip and extract information. By making it easier for the Air Traffic Controller to extract information from the electronic flight strip and maintain situational awareness, the method of the present invention can also help to mitigate against mistakes arising from human error and thereby improve aviation safety.

The display fields may include both static display fields, which do not change when the electronic flight strip is moved from the first bay to the second bay, and dynamic display fields, which do change when the electronic flight strip is moved from the first bay to the second bay. The static display fields may change from a hidden state to a visible state (or vice versa) when the electronic flight strip is moved from the first bay to the second bay.

The electronic flight strip configuration may cause the electronic flight strips to display interactive elements, such as task buttons. These elements may be dynamic, such that the visibility and functionality of the interactive element is based on the aircraft location.

The bays may also be referred to as segments.

Optionally, the template defines a set of operational values and a set of user permissions.

Optionally, the set of operational values are preselected from a group comprising: Clearance Limits; Squawks; Approach Types; Airways; Taxi Vias; Approach Positions; Runways; Levels; Clearances; Relative Tos; Vehicle Operations; Service Vehicles; Frequency Transfers; Next Frequencies; Custom Waypoints; VOR Waypoints; IFR Waypoints; VFR Waypoints; Orbit Waypoints; Hold Waypoints; En-route Waypoints; Circuits; and Parking.

Optionally, the electronic flight strips include a colour element (such as background shading) to denote a Flight Movement Type associated with the electronic flight strip. The Flight Movement Type may be one of Departure, Arrival, Local or Overflight. Using different colour elements for different Flight Movement Types allows Air Traffic Controllers to quickly see what type of flight the electronic flight strip corresponds to.

Optionally, the bays of the flight board are selected from a group of bays comprising: Pending Departures, Active, Taxiway, Runway, Inbound/Outbound, Circuit, Overflight, Pending Arrivals. Alternative names may be used for bays having the same respective underlying functions. It should be understood that the first and second bays are not necessarily displayed first or second on the display. The first and second bays are preferably associated with bays of an electronic flight progress board (which may also be referred to as a digital flight progress board).

Optionally, the method further comprises receiving and storing a mutated electronic flight strip from a remote device corresponding to the remote user. This ensures that the electronic flight strip system instantiations remains up to date, allowing it to serve as a remote backup for the purposes of resilience and non-repudiation. An electronic flight strip may be mutated by moving it from one bay to another, or by modifying the value of a field associated with the electronic flight strip. The mutations may be performed locally, on the remote user's device. A copy of the mutated electronic strip is then transmitted to the remote electronic flight strip server.

Preferably, the preconfigured electronic flight strip system instantiation defines a set of rules for aircraft movements against which a detected user input on the remote display is validated.

Optionally, the method further comprises providing instructions to generate an exception if an invalid aircraft movement is detected

For example, a notification may be displayed to the Air Traffic Controller if a “forbidden” action is detected such as moving an Overflight electronic flight strip into the bay associated with the Runway. The Air Traffic Controller can then take suitable action (for example, moving the electronic flight strip to a correct bay or updating the Flight Movement Type). In some cases, an exception may be generated if an invalid/unsafe aircraft movement is detected. In another example, a notification may be displayed if an Air Traffic Controller attempts to move an electronic flight strip into Runway bay which already contains the maximum number of aircraft. In a further example, a notification may be displayed if an Air Traffic Controller attempts to move an electronic flight strip from a bay associated with Arrivals to a bay associated with a Taxiway, without the intermediate step of moving through a Runway bay.

Optionally, the method further comprises serving the pre-configured electronic flight strip system instantiation for display and user interaction on a different display. For example, the different display may be at a different location to the display such as a different aerodrome. Alternatively, the display and the different display may be at the same location (i.e., same aerodrome). Transmitting the electronic flight strip to a different display allows flight control responsibility to be transferred between different Air Traffic Controllers that are using different displays.

Optionally, the different display is at a remote location (e.g. a different aerodrome).

Optionally, the different display is at a local location (e.g. the same aerodrome, but another device).

The method is preferably performed over a network from a cloud-based computing resource coupled to an aerodrome operating one or more displays for the provision of Air Traffic Services. Existing electronic flight strip systems are generally based on-site at an aerodrome. In contrast, the method of the present invention allows for a cloud-based electronic flight strip system.

Preferably, the method comprises maintaining a stored digital record for electronic flight strips representing aircraft movements over time. This allows aircraft movements over time to be reconstructed during an investigation.

Optionally, the method comprises receiving a query requesting a subset of the stored digital record from the remote user; processing the stored digital record in response to the query to extract the requested subset; and serving the requested subset to a remote device corresponding to the remote user.

Optionally, the method comprises providing instructions for displaying a flight creation dialogue on the display, wherein the flight creation dialogue comprises a plurality of data entry fields, wherein the plurality of data entry fields comprises a subset of data entry fields configured from a set of data entry fields, and wherein the plurality of data entry fields is selected from the set of data entry fields based on a Flight Movement Type input by the user.

Optionally, serving a pre-configured electronic flight strip system instantiation comprises selecting the pre-configured electronic flight strip system instantiation from a plurality of pre-configured electronic flight strip system instantiations, wherein each pre-configured electronic flight strip system instantiations is associated with a different set of remote users. This means that multiple instantiations can be accessed through the same electronic flight strip server, as opposed to each instantiation being hosted separately on a dedicated server.

Optionally each set of remote users corresponds to a different set of aerodromes. In other words, a single electronic flight strip system infrastructure can host instantiations for multiple customers, each customer being responsible for one or more aerodromes.

This reduces installation and maintenance costs, compared to providing a dedicated local or remote server for each aerodrome. To ensure security, a remote user only accesses the instantiation(s) associated with the user's aerodrome(s).

The pre-configured electronic flight strip system instantiation may be adapted based on specific duties that the user is authorised to perform.

Preferably, the electronic flight strip system instantiation includes configuration information, the configuration information including a set of user permissions, and the method further comprises adapting the pre-configured electronic flight strip instantiation for the remote user according to the set of user permissions. For example, the instantiation may define a plurality of flight boards representing different aircraft movement types (e.g. a Ground board and an Approach board). The electronic flight strip system may be adapted such that a particular user can access the Ground board, but not the Approach board. The set of user permissions may correspond to the role of the remote user, such as whether the user is a Split Position controller or an Assistant controller. When the remote user logs in, the set of user permissions is selected based on the remote user's role.

Preferably, serving the pre-configured electronic flight strip system instantiation further comprises providing instructions to authorise user interactions for the remote user according to the set of user permissions. For example, one user may be authorised to view and mutate electronic flight strips, while another user (such as an assistant Air Traffic Controller) may be authorised to view electronic flight strips but not mutate them (or to only mutate certain aspects).

The method of the second aspect may further comprise performing the method of the first aspect.

According to a third aspect of the invention, there is provided an electronic flight strip system apparatus configured to perform the method of the first and/or second aspects.

According to a fourth aspect of the invention, there is provided a computer program product comprising instructions which, when executed by a processor, cause the processor to perform the method of the first and/or second aspects.

Optionally, authenticating the remote user login request comprises transmitting the remote user login request to an authentication server and receiving an authentication confirmation from the authentication server.

According to a second aspect of the invention, there comprises a computer implemented method for configuring an electronic flight strip system configuration over a network, the method comprising: receiving and authenticating a remote user login request; serving an initial electronic flight strip system template for display and user interaction through a configurator interface on a remote display; modifying a parameter of the initial electronic flight strip system template in response to instructions received from the configuration interface to create an electronic flight strip system configuration which defines a flight board divided into a number of bays, each bay being associated with a respective type of aircraft location, and electronic flight strips having data fields which are determined and populated according to which bay the electronic flight strip is located; and, saving the modified electronic flight strip system configuration and associating the saved modified electronic flight system configuration with a remote user

Preferably, the one or more flight board layouts are each divided into a number of bays, each bay being associated with a respective type of aircraft location, wherein each bay is configured to display electronic flight strips, each electronic flight strip having data fields which are determined and populated according to which bay the electronic flight strip is located.

Optionally, modifying a parameter of the initial electronic flight system template comprises modifying a characteristic of a bay of a flight board layout.

Optionally, the modifiable characteristics of a bay modify one or more of: the type of aircraft location associated with the bay; the data fields to be determined and populated on electronic flight strips located in the bay; a position of the bay on the flight board layout; a size of the bay on the flight board layout; a sorting order in which electronic flight strips will be located in the bay; and, a display name of the bay.

Optionally, modifying a parameter of the initial electronic flight system template comprises selecting a bay for the flight board layout from a pre-configured set of bay templates. Providing a set of pre-configured template bays further streamlines the process of configuring a template for a user.

Optionally, serving the initial electronic flight strip system configuration comprises selecting the initial electronic flight strip system template from a set of initial electronic flight strip system templates stored on the configuration server, wherein each initial electronic flight strip system template is associated with a different set of remote users.

Optionally, each set of remote users corresponds to a different aerodrome.

According to a third aspect of the invention, there is provided a computer implemented method for operating an electronic flight strip system, the method comprising: detecting a user input on a display that displays an electronic flight strip having a first set of display fields associated with a first type of aircraft location within a first bay of a display area of the display reserved for the first type of aircraft location; and, in response to the detected user input, moving the electronic flight strip from the first bay to a second bay of the display area reserved for a second type of aircraft location and modifying the electronic flight strip to have a second set of display fields associated with the second type of aircraft location.

The first and second sets of display fields may be a respective proper subset of display fields configured from a set of display fields. The set of display fields may comprise a plurality of the following: Callsign, Squawk, Image Element, Aircraft Type, Wake Category, Flight Rules, Persons Onboard, Flight Priority Category, Frequency Transfer, Service, Estimated Time of Departure, Estimated Off Blocks Time, Calculated Take-off Time, Actual Time of Departure, Estimated Time of Arrival, Estimated Approach Time, Actual Time of Arrival, Parking, Clearance Limit, Approach Type, Departure Runway, Arrival Runway, Route, Report, Level, Next Frequency After Departure, Speed, Origin, Destination, Touch & Go/Go Around, Direction. Additional and/or alternative display fields may also be used.

The Image Element is used to denote a category of aircraft or vehicle. Using such an Image Element allows Air Traffic Controllers to quickly identify what category of aircraft the electronic flight strip corresponds to. This can assist the Air Traffic Controller in quickly determining aircraft characteristics e.g., safe aircraft separation distances, or other performance and/or safety characteristics. The image element may take the form of a silhouette, or a 3D model of the aircraft or vehicle.

The method may optionally further comprise logging movement of the electronic flight strip from the first bay to the second bay and storing an updated electronic flight strip in memory and/or associating the movement with a chargeable service for subsequent invoicing in an e-billing service.

Optionally, the method may further comprise detecting another user input at a location on the electronic flight strip in one of the first and second bays and updating the display of one or more data fields of the electronic flight strip within that bay. For example, the other user input may comprise the user interacting with a task button. For example, the task button may be used to indicate that a flight has become airborne, which may automatically populate the Actual Time of Departure and update the selection of data fields displayed on the electronic flight strip without the electronic flight strip being moved to a different bay.

Optionally, the method may further comprise serving a pre-configured electronic flight strip system instantiation for the aerodrome and maintaining a stored digital record for the electronic flight strip over time.

The user input may comprise dragging and dropping the electronic flight strip from the first bay to the second bay.

Preferably, the display is a touch enabled display and the user input is touch.

Optionally, the method may further comprise displaying a flight creation dialogue on the display, wherein the flight creation dialogue comprises a plurality of data entry fields, wherein the plurality of data entry fields comprises a subset of data entry fields selected from a set of data entry fields based on a Flight Movement Type input by the user.

Preferably, each respective display field is displayed with a respective label. Optionally, at least one respective label may be selected based upon a respective data value of the respective display field. For example, when a display field (such as Route) has a first value it may be displayed with a first label, and it may be displayed with a second label different to the first label when it has a second value different to the first value. The labels may optionally correspond to a data value group from which the respective data value is selected.

Preferably, the preconfigured electronic flight strip system instantiation defines a flight board divided into a number of bays, each bay being associated with a respective type of aircraft location, and electronic flight strips having data fields which are determined and populated according to which bay the electronic flight strip is located.

The method of the third aspect may further comprise performing the method of the first or second aspect.

According to a fourth aspect of the invention, there is provided an electronic flight strip system apparatus configured to perform the method of the first, second and/or third aspects.

According to a fifth aspect of the invention, there is provided a computer program product comprising instructions which, when executed by a processor, cause the processor to perform the method of the first, second, third and/or fourth aspects.

### BRIEF DESCRIPTION OF THE DRAWINGS

Examples of the present invention will now be described in detail with reference to the accompanying drawings, in which:

FIG. 1 illustrates an electronic flight progress board;

FIG. 2 illustrates an alternative electronic flight progress board having a different layout to the electronic flight progress board in FIG. 1;

FIG. 3 illustrates an electronic flight strip;

FIGS. 4a-d illustrate the layout of electronic flight strips associated with different bays of the electronic flight progress board;

FIGS. 5a-c illustrate electronic flight strips with different dynamic task buttons;

FIGS. 6a-b illustrate electronic flight strips with different Flight Rules;

FIGS. 7a-b illustrate electronic flight strips having different Flight Priority Category values;

FIGS. 8a-d illustrate electronic flight strips associated with different Flight Movement Types;

FIGS. 9a-e illustrate data entry dialogues for different Flight Movement Types;

FIG. 10 illustrates a method for operating an electronic flight strip system;

FIG. 11 illustrates a method for providing an electronic flight strip system over a network;

FIG. 12 illustrates an electronic flight strip system apparatus;

FIG. 13 illustrates multiple terminals accessing an electronic flight strip system;

FIGS. 14a and 14b illustrate exemplary rules for displaying data on an electronic flight strip;

FIG. 15a-c illustrate how a splitter bay may be incorporated into a portion of an electronic flight progress board;

FIGS. 16a and 16b illustrates a method for configuring an electronic flight strip configuration over a network; and,

FIG. 17 is a table illustrating out a set of user permissions associated with an electronic flight strip configuration.

### DETAILED DESCRIPTION

Aspects of the invention relate to methods for operating an electronic flight strip system and for providing an electronic flight strip system over a network. The electronic flight strip system is a digital replacement for traditional paper or plastic chip-based flight progress boards.

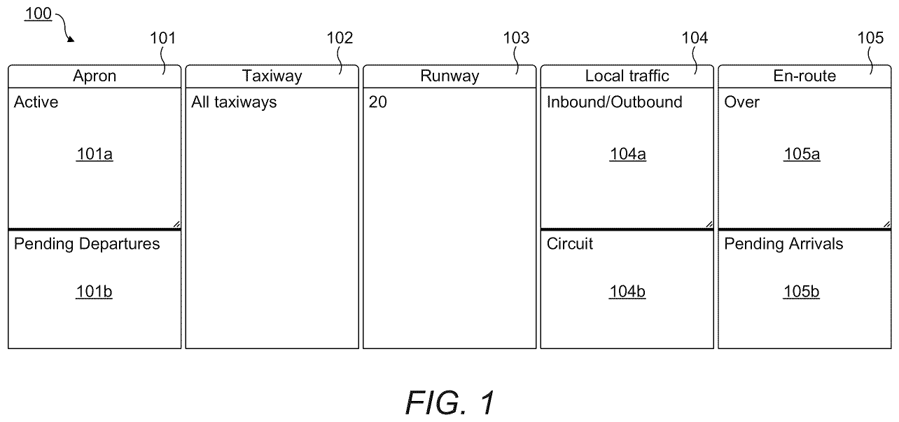

FIG. 1 illustrates an exemplary electronic flight progress board 100 (also referred to herein as an electronic flight progress board, or more simply as a board). The board 100 is associated with a single aerodrome and features a plurality of columns 101-105 each representing physical spaces or phases that an aircraft can operate in, each column being displayed on the flight progress board 100. For example, in the illustrated board 100 the first column 101 represents the Apron, the second column 102 represents the Taxiway, the third column 103 represents the Runway, the fourth column 104 represents Local Traffic (i.e., in close vicinity to the aerodrome), and the fifth column 105 represents En-route Traffic.

Each column is formed of one or more bays, each representing an aircraft location. In the present application, the term “aircraft location” should be understood to refer to the actual physical location of an aircraft (e.g., the runway) and/or to a phase of flight associated with the aircraft (e.g., pending departures or pending arrivals). The Taxiway column 102 and Runway column 103 are each formed as a single bay. The Apron column 101, Local Traffic column 104 and En-route column 105 are each split into multiple bays. In particular, the Apron column 101 is split into an Active bay 101a and a Pending Departures bay 101b, the Local Traffic column 104 is split into an Inbound/Outbound bay 104a and a Circuit bay 104b, and the En-route column 105 is split into an Over bay 105a and a Pending Arrivals bay 105b. Each column may represent either a subset of physical space (e.g., Circuit vs Inbound) or a difference in aircraft state (e.g., Pending Departures-parked aircraft expected to fly vs Active-parked aircraft with engines running), or a convenient grouping of bays.

Board layouts can be adjusted to suit customer preferences. An exemplary method for configuring the board layouts of an electronic flight system configuration will be described below. While the illustrated bays 101-105 of the board 100 in FIG. 1 are shown with 5 columns, alternative board layouts are also configurable in which the plurality of bays are instead represented using other layouts with a configurable number of columns or rows. In addition, the columns may be split into different bays to those illustrated in FIG. 1.

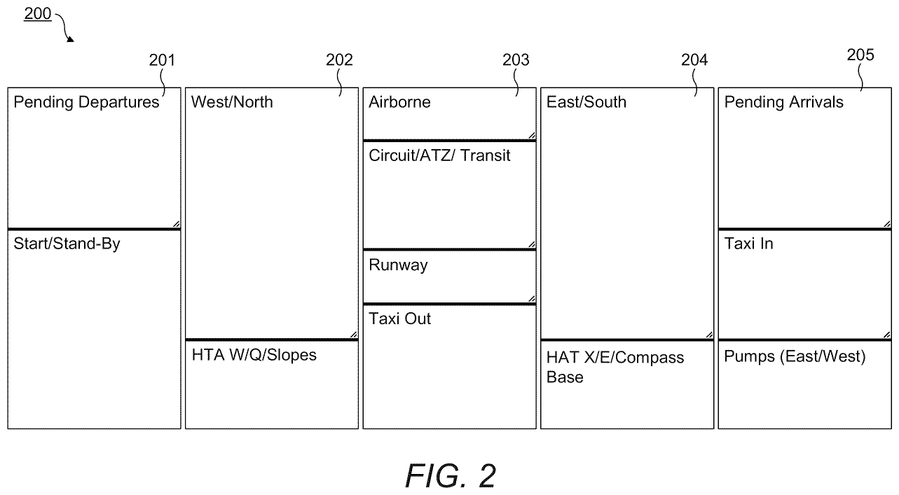

An exemplary alternative board 200 is illustrated in FIG. 2. The alternative board 200 has five columns 201-205 with the same underlying bay types as the respective bays in columns 101-105 of board 100 in FIG. 1 (namely Apron, Taxiway, Runway, Local Traffic and En-route), but these columns have been split into additional bays compared to the board 100 of FIG. 1. Several of the bays have been labelled with different names compared to the board 100 of FIG. 1.

Alternative configurations could also be used with more or fewer bays (for example, a board may have fewer bays when different Air Traffic Controllers are responsible for Departures and Arrivals).

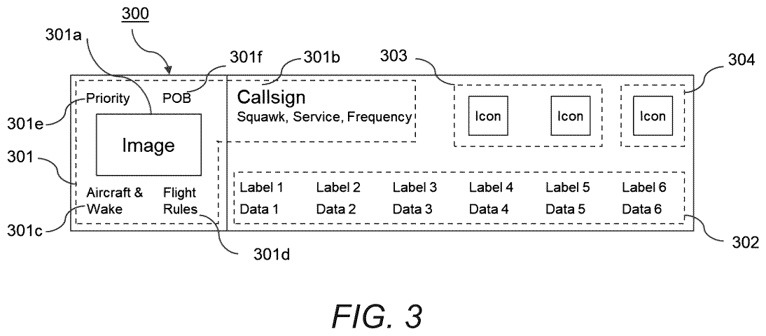

Electronic flight strips (also referred to as digital flight strips, electronic flight cards or digital flight cards) placed in different bays of the electronic flight progress board 100, 200 can be used by Air Traffic Controllers to represent flight progress. An exemplary electronic flight strip 300 is shown in FIG. 3. This electronic flight strip 300 can be placed in any bay of an electronic flight progress board (e.g., those shown in FIGS. 1 and 2), but can only ever be in one bay.

The electronic flight strip 300 comprises a plurality of static display fields 301 that are shown regardless of which bay the electronic flight strip 300 is placed in, and a plurality of dynamic display fields 302 that change depending upon which bay the electronic flight strip 300 is placed in (that is, the selection of fields displayed is adjusted dynamically depending upon the position of the electronic flight strip 300 on the board 100, 200). The electronic flight strip 300 also features a plurality of dynamic task buttons 303, which change depending upon the position of the electronic flight strip 300 on the board and the status of the flight, and one or more static task buttons 304 (such as a menu button) that are always displayed regardless of the position of the electronic flight strip 300.

The static data fields 301 may include an Image Element (Image) 301a to denote a category of aircraft (or any other vehicle that may be present at the aerodrome), the flight's Callsign, Squawk, Service and Next Frequency After Departure\Frequency Transfer (Frequency) 301b, Aircraft Type and Wake Category 301c, Flight Rules 301d, Flight Priority Category (Priority) 301e and Persons Onboard (POB) 301f. It should be understood that only a subset of these static data fields may be shown, or that additional/alternative static data fields could be used instead of the illustrated static data fields 301.

The selected dynamic fields 302 can depend on one or more of either the bay a flight strip is placed in, the state of the flight strip (e.g., ground or airborne), the Flight Rules a flight is operating under (e.g., Instrument Flight Rules (IFR) or Visual Flight Rules (VFR)), or the Flight Movement Type of the flight strip (e.g., Departure, Arrival, Local or Overflight).

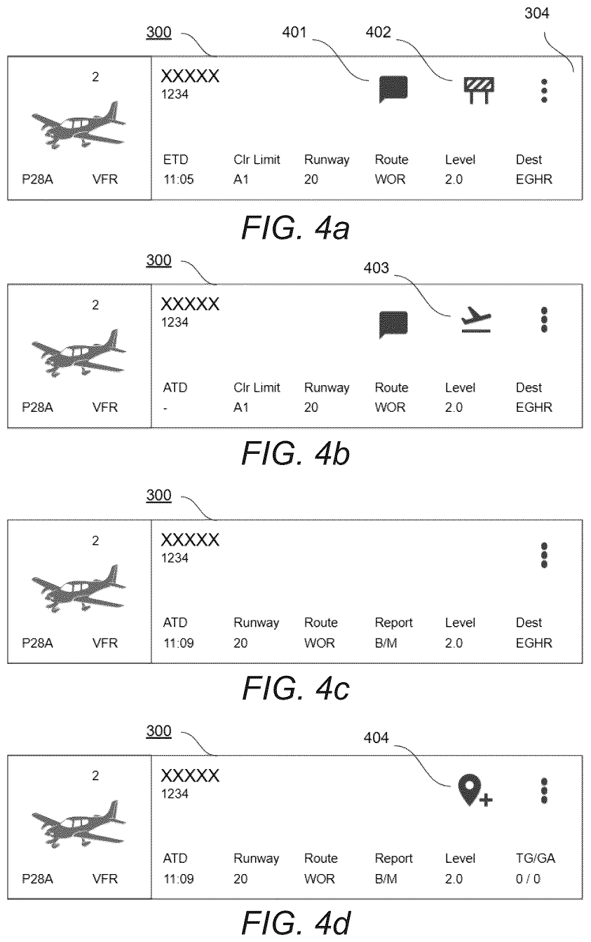

FIGS. 4a-d illustrate how the dynamic fields 302 vary when an electronic flight strip 300 is moved between different bays on the board 100. The electronic flight strip 300 is placed into a bay by the Air Traffic Controller based upon the associated aircraft's geographical position in three-dimensional space or a phase of flight. As the aircraft's flight progresses, the Air Traffic Controller updates the position of the electronic flight strip 300 across different bays. The Air Traffic Controller also updates electronic flight strip data fields as the flight progresses. Flight data that was relevant at the initial stage of flight might not be relevant at a later stage of flight. Therefore, only a (proper) subset of all possible dynamic fields is displayed based on predefined rules that define the dynamic fields to be displayed based on the bay that the electronic flight strip 300 is placed in and the Flight Movement Type.

FIG. 4a shows exemplary dynamic fields that may be displayed when an electronic flight strip 300 associated with a Local Flight Movement Type is positioned in the Taxiway bay of the Taxiway column 102. In particular, the dynamic fields that are displayed are Estimated Take-Off Time (ETD), Clearance Limit (Clr Limit), Runway, Route, Level and Destination (Dest).

When the electronic flight strip 300 is moved to the Runway column 103 (which has a single bay) in a ground state, the dynamic fields may be updated as shown in FIG. 4b. In particular, the Estimated Time of Departure (ETD) field is replaced with Actual Time of Departure (ATD). Once the flight takes off, the Air Traffic Controller can update the electronic flight strip 300 to change the state to an air state. The dynamic fields may then be updated once again as shown in FIG. 4c, where it can be seen that the Clearance Limit (Clr Limit) field has been removed and a new Report field has been added. The positions of several of the other fields have also been adjusted. Finally, when the electronic flight strip 300 is moved to the Inbound/Outbound bay 104a, the fields may be updated as shown in FIG. 4d, in which the Destination (Dest) field has been replaced with a Touch & Go/Go Around (TG/GA) field.

While only a subset of data is displayed at any one time, it should be understood that all of the data associated with the electronic flight strip (including data no longer being displayed) is generally stored throughout the lifetime of the electronic flight strip and can be accessed by the Air Traffic Controller by e.g., opening a menu dialogue that displays all information associated with an electronic flight strip.

As also shown in FIGS. 4a-d, in addition to the dynamic fields being updated dependent upon the bay and flight status, the dynamic task buttons 303 may also change as the flight progresses. In FIG. 4a, the electronic flight strip 300 features two dynamic task buttons: a Departure task button 401, and a Taxi task button 402. When the electronic flight strip 300 is moved to the Runway column 103 in the ground state (shown in FIG. 4b) the Taxi task button 402 is replaced with a Take-off button 403. No dynamic task buttons are displayed when the electronic flight strip 300 is positioned in the Runway column 103 in the air state (shown in FIG. 4c). When the electronic flight strip 300 is moved to the Inbound/Outbound bay 104a, a General task button 404 is displayed (shown in FIG. 4d). The static menu task button is displayed throughout.

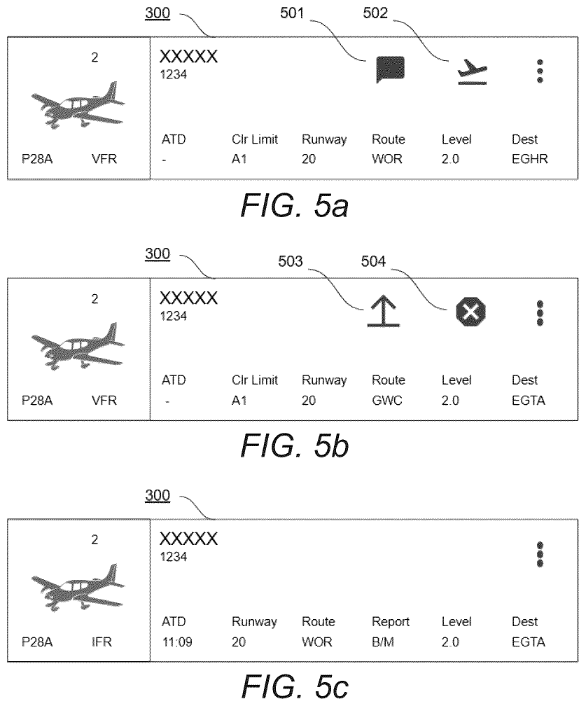

Each of the dynamic task buttons 303 can be used to perform a particular function such as updating data associated with the electronic flight strip 300 or displaying a menu (e.g., for data entry). FIGS. 5a-c illustrate some exemplary functions. The logo and/or colour of the dynamic task buttons 303 change to indicate their current functions, reducing a user's cognitive workload.

The electronic flight strip 300 in FIG. 5a corresponds to the electronic flight strip 300 in FIG. 4b. That is, the electronic flight strip 300 in FIG. 5a represents a Local flight in the Runway column 103 having a ground state (i.e., the flight is not yet airborne). As in FIG. 4b, the electronic flight strip 300 displays a Departure task button 501 and a Take-off task button 502.

When the Air Traffic Controller interacts with the Take-off task button 502 (e.g., by clicking the button with a mouse or by touching the button on a touch screen), the dynamic task buttons 303 are updated to show an Airborne task button 503 and a Revoke task button 504 as shown in FIG. 5b. The dynamic display fields 302 remain the same.

Interacting with the Revoke task button 504 will cause the electronic flight strip 300 to return to the state shown in FIG. 5a. Interacting with the Airborne task button 503 will update the flight state to the air state and automatically populate the Actual Time of Departure (ATD) with the current Coordinated Universal Time\Universal Time Coordinated (UTC). This will also cause the dynamic task buttons 303 to disappear and will cause the dynamic display fields 302 to update as shown in FIG. 5c. It should be understood that these dynamic task buttons 303 are exemplary only, and that different and/or additional/fewer dynamic task buttons 303 could be displayed as required.

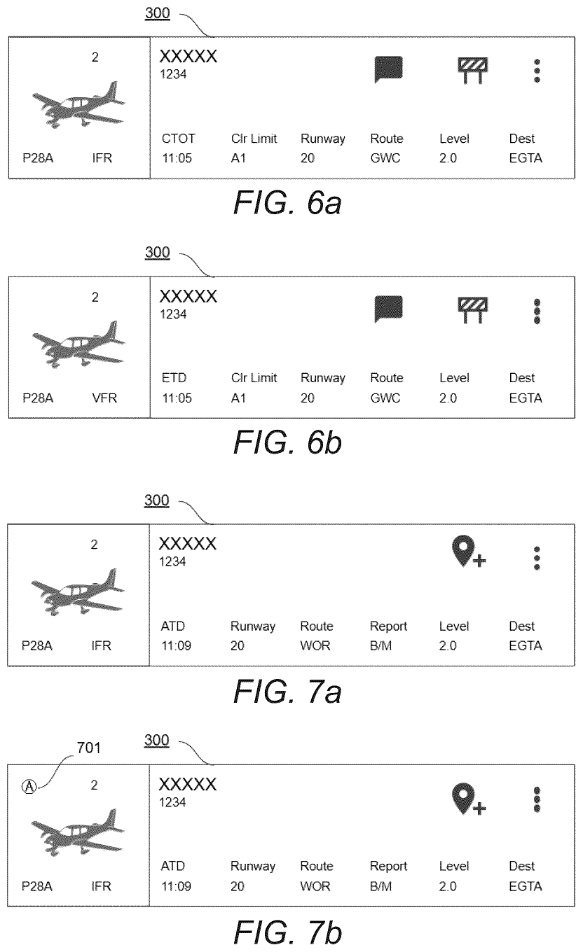

Different dynamic display fields 302 (and static display fields 301) may also be displayed based upon the Flight Rules an aircraft is operating under. For example, the electronic flight strip 300 in FIG. 6a represents a flight operating under Instrument Flight Rules (as represented by the text “IFR” in the static display fields 301), and the electronic flight strip 300 in FIG. 6b represents a flight operating under Visual Flight Rules (as represented by the text “VFR” in the static display fields 301). In FIG. 6a, the leftmost dynamic display field is Calculated Take-off Time (CTOT), whereas the leftmost dynamic display field in FIG. 6b is Estimated Time of Departure (ETD).

Display fields may also be selectively displayed or hidden based upon data values associated with the electronic flight strip. For example, when a flight is operating with a Flight Priority Category data value ‘N’ or ‘Z’, this may be omitted from the electronic flight strip 300 as shown in FIG. 7a. However, when the Flight Priority Category data value is set to ‘A’, ‘B’, ‘C’, ‘D’ or ‘E’, this may be displayed as a static display field as shown in FIG. 7b, which illustrates an electronic flight strip 300 having a Flight Priority Category value ‘A’ displayed using an icon 701.

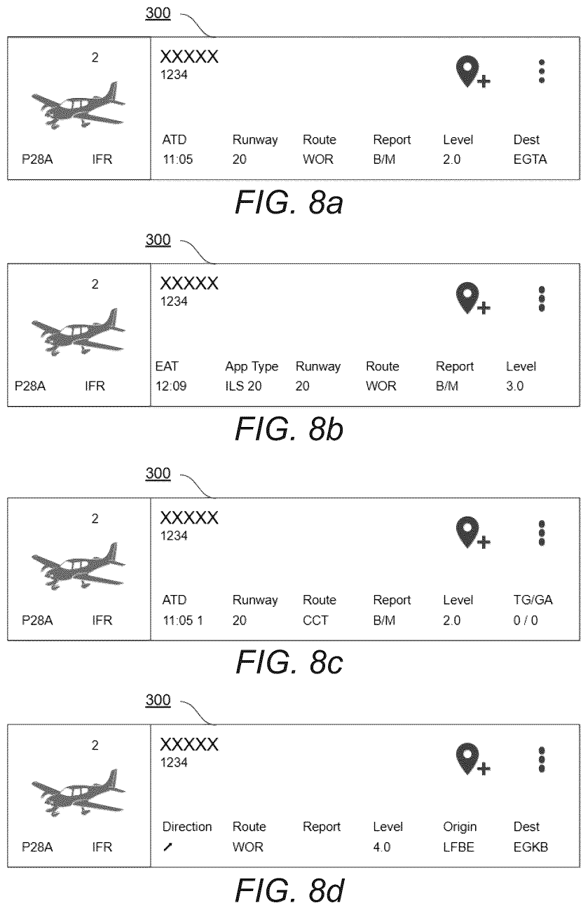

As discussed above, the dynamic display fields 302 shown on the electronic flight strip 300 can also depend on the Flight Movement Type of the aircraft. FIGS. 8a, 8b, 8c and 8d illustrate electronic flight strips 300 associated with Departure, Arrival, Local and Overflight Flight Movement Types respectively. As an example, a Departure may take-off from the aerodrome associated with the board 100 and land at a different aerodrome, an Arrival may take-off from a different aerodrome and land at the aerodrome associated with the board 100, a Local may take-off and land at the aerodrome associated with the board 100, and an Overflight may take-off and land at a different aerodrome or different aerodromes.

In addition to displaying different dynamic display fields 302, the dynamic task buttons 303 displayed may also be different depending upon the Flight Movement Type. Furthermore, a colour element of the electronic flight strip 300 may also vary depending upon the Flight Movement Type. For example, Departure electronic flight strips may have a blue background, Arrival electronic flight strips may have an orange background, Local electronic flight strips may have a pink background, and Overflight electronic flight strips may have a green background. Alternative colours may be used, and/or an icon/written description on the electronic flight strip 300 may be used to indicate Flight Movement Type.

In some situations, the Flight Movement Type of an aircraft may change, e.g., if the aircraft was an Overflight but now wishes to land at the aerodrome. In this case, the Air Traffic Controller can change the Flight Movement Type associated with the electronic flight strip 300, which will update the display fields and colour element accordingly.

In addition to displaying different display fields depending upon the Flight Movement Type, different data entry fields may also be displayed to the Air Traffic Controller when creating electronic flight strips having different Flight Movement Types.

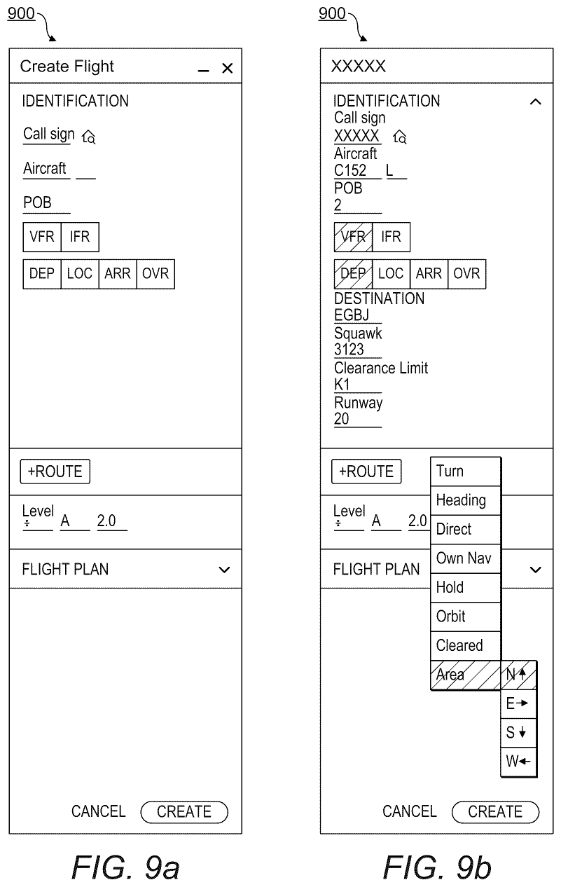

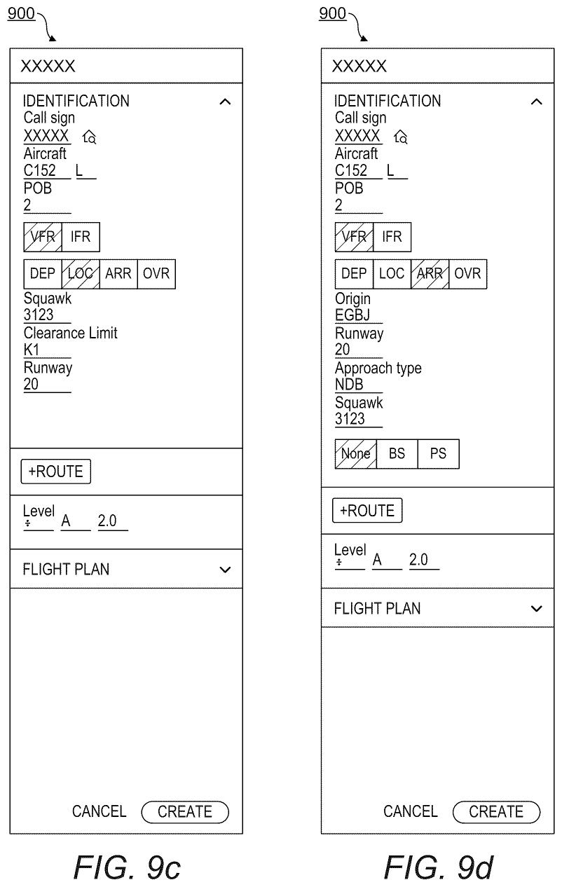

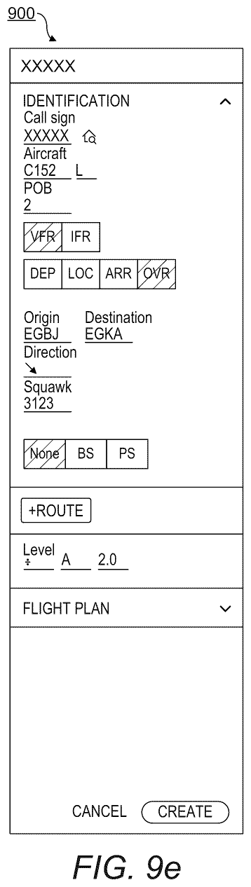

FIG. 9a illustrates an exemplary electronic flight strip creation dialogue 900 before a Flight Movement Type has been selected. Once the Air Traffic Controller selects a Flight Movement Type for the electronic flight strip, appropriate data entry fields are displayed based upon the selected Flight Movement Type. FIGS. 9b, 9c, 9d and 9e show exemplary electronic flight strip creation dialogues 900 for Departure, Local, Arrival and Overflight Flight Movement Types respectively. A colour element may again be displayed depending upon the Flight Movement Type. For example, the header bar of the electronic flight strip creation dialogue 900 may be updated to match the background colour used on the electronic flight strip 300 for each Flight Movement Type.

An electronic flight strip creation dialogue 900 may allow a previously archived electronic flight strip to be retrieved, or alternatively used as a template electronic flight strip. Retrieving an archived electronic flight strip allows an electronic flight strip to be hidden from a flight board, and then re-introduced. The values of the data fields of the retrieved electronic flight strip are identical to when the electronic flight strip was archived. Alternatively, the electronic flight strip may be used a template. A template strip retains some of the values of the data field values of the archived electronic flight strip (such as those associated with the aircraft itself), with others (such as those associated with the aircraft's last flight movement) being left blank or set to a default value.

For example, an aircraft may land at an aerodrome, become inactive for a period of time, and then fly out of the aerodrome again. The aircraft's electronic flight strip is archived when the aircraft parks and becomes inactive. When the aircraft readies for departure, the archived electronic flight strip is used as a template, duplicating the information about the aircraft itself, but not the details of the aircraft's last flight movement.

In some examples, electronic flight strips can be selected for retrieval from a set of archived electronic flight strips. The set of archived electronic flight strips may be displayed to the user in a window or dialogue box. To enable a user to find a particular archived electronic flight strip, interactive elements may be provided which allow a user to sort the archived electronic flight strips (e.g. by time/date archived), or filter/search the archived electronic flight strips (e.g. by name or type of aircraft).

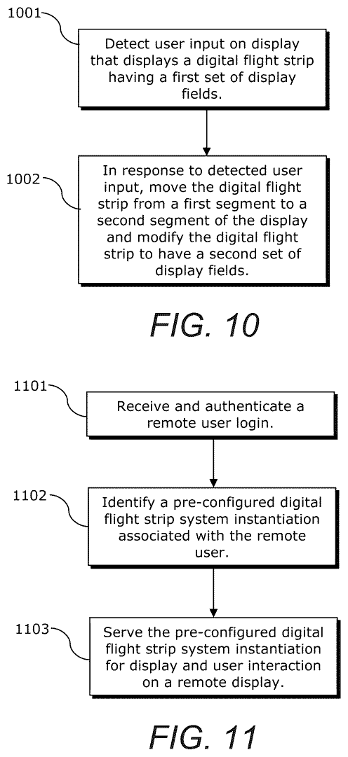

FIG. 10 illustrates a method for operating an electronic flight strip system that uses electronic flight strips 300. The method of FIG. 10 may be performed over a network from a cloud-based computing resource coupled to an aerodrome operating one or more displays for provision of Air Traffic Control services.

In step 1001, a user input is detected on a display that displays an electronic flight strip having a first set of display fields. The electronic flight strip may be an electronic flight strip 300 as described above, and it may be displayed on an electronic flight progress board 100, 200 such as those shown in FIG. 1 or 2.

The user input causes an electronic flight strip to be mutated.

The user input may involve the user dragging and dropping the electronic flight strip from a first bay of the flight progress board to a second bay of the flight progress board. For example, the user may use an input device such as a mouse, or they may use a touch gesture if the display is a touch enabled display.

In step 1002, the electronic flight strip is moved from a first bay of the display to a second bay of the display in response to the detected user input. Moving the electronic flight strip may involve displaying one or more animations as the flight strip is moved. The first bay may be a first bay of an electronic flight progress board such as those shown in FIGS. 1 and 2, and the second bay may be a second bay of the electronic flight progress board. These boards may be served as a pre-configured electronic flight strip instantiation for the aerodrome, and a stored digital record may optionally be maintained for the flight strip over time. One copy of the stored digital record may be maintained locally on a device associated with the remote user, while another copy is received by the electronic flight strip system server, ensuring that there is a remote backup.

Also in step 1002, the electronic flight strip is modified to have a second set of display fields in place of the first set of display fields, wherein the second set of display fields contains different display fields to the first set of display fields. The first and second sets of display fields may each comprise a respective (proper) subset of display fields selected from a set of display fields. This set of display fields may include one or more of Callsign, Squawk, Image Element, Aircraft Type, Wake Category, Flight Rules, Persons Onboard, Flight Priority Category, Frequency Transfer, Service, Estimated Time of Departure, Estimated Off Blocks Time, Calculated Take-off Time, Actual Time of Departure, Estimated Time of Arrival, Estimated Approach Time, Actual Time of Arrival, Parking, Clearance Limit, Approach Type, Departure Runway, Arrival Runway, Route, Report, Level, Next Frequency After Departure, Speed, Origin, Destination, Touch & Go/Go Around, and Direction.

The method may also involve logging movement of the electronic flight strip from the first bay to the second bay and storing an updated, mutated electronic flight strip in memory. A copy of the mutated electronic flight strip may be stored locally, on a device associated with the remote user. A copy of the mutated electronic flight strip may be received by the electronic flight strip system server from the device associated with the remote user. The electronic flight strip server can thus generate and maintain accurate movement logs. Logging movement of the electronic flight strip provides a record of flight actions, which is important in the event of post-flight investigations. The movement may also be associated with a chargeable service for subsequent invoicing in an e-billing service.

To optimise memory allocation, only a subset of the full digital record, mutated flight strips, or movement logs may be locally stored on the device associated with the remote user. For example, the locally-storied copy may contain only the digital record, and/or mutated flight strips for a full day's operation at the aerodrome.

Conversely, the electronic flight strip system may, in response to instructions from a remote user, serve a subset of the remotely-stored digital record and/or mutated flight strips to a device associated with the remote user. For example, a remote user conducting an investigation into a particular aircraft's movements may submit a query to the electronic flight strip system server, requesting movement logs for that aircraft over a specified time period. The electronic flight strip system server processes the remotely stored movement logs in response to the query, and then serves the requested data to a device associated with the remote user. This enables users to access the digital history associated with their aerodrome for analysis, without requiring the aerodrome to store and secure large amounts of data on-premises.

Optionally, the method of FIG. 10 may further comprise detecting another user input at a location on the electronic flight strip in one of the first and second bays and updating the display of one or more data fields of the electronic flight strip within that bay. The other user input may involve the user interacting with one or more task buttons (for example, the dynamic task buttons 303 described above). The data fields may be updated to have different values. Additionally, or alternatively, updating the data fields may involve modifying the electronic flight strip to have a third set of display fields associated with the second type of aircraft location (the third set may again be a proper subset of display fields selected from a set of display fields as described above).

In addition, the method may also optionally involve validating the user input against a set of rules for aircraft movement. For example, a notification may be displayed to the Air Traffic Controller if a “forbidden” action is detected such as moving an Overflight electronic flight strip into the bay associated with the Runway. The Air Traffic Controller can then take suitable action (for example, moving the electronic flight strip to a correct location or updating the Flight Movement Type). In some cases, an exception may be generated if an invalid aircraft movement is detected.

The method may also involve displaying a flight creation dialogue on the display such as those described in FIGS. 9a-e. As discussed above, the flight creation dialogue may comprise a plurality of data entry fields comprising a subset of data entry fields selected from a set of data entry fields based on a Flight Movement Type input by the user (Air Traffic Controller).

The electronic flight strip system may be in communication with other instantiations of an electronic flight strip system (for example, an instantiation of the electronic flight strip system on another display at the same aerodrome, or an instantiation of the electronic flight strip system on a display at a different aerodrome), and the electronic flight strip may be transmitted (e.g., over a local area network or wide area network via communication means coupled to the display) to a different display.

FIG. 11 illustrates a method for providing an electronic flight strip system over a network. The method shown in FIG. 11 is preferably used in combination with the method shown in FIG. 10.

At step 1101, a remote user login request associated with a remote user is received from a client computing device and authenticated by an electronic flight strip system server or an authentication server associated with the electronic flight strip system server. The authentication server may be a component of the electronic flight strip system, or it may alternatively be provided and administered as part of another system and or/by a third party.

In step 1102, a pre-configured electronic flight strip system instantiation associated with the remote user is identified by the electronic flight strip system server.

In step 1103, the electronic flight strip system server serves the pre-configured electronic flight strip system instantiation to a client computing device for display on a display of the client computing device. Once served to the client computing device, the electronic flight strip system instantiation can receive user inputs from the remote user (i.e., an Air Traffic Controller) in order to e.g., perform the method of FIG. 10.

The pre-configured electronic flight strip system instantiation may include configuration information including board layout. For example, the configuration information may indicate a board layout such as that shown in either FIG. 1 or FIG. 2. The configuration information may also include information such as user permissions, which may optionally indicate whether the remote user (i.e., Air Traffic Controller) is authorised to perform specific duties.

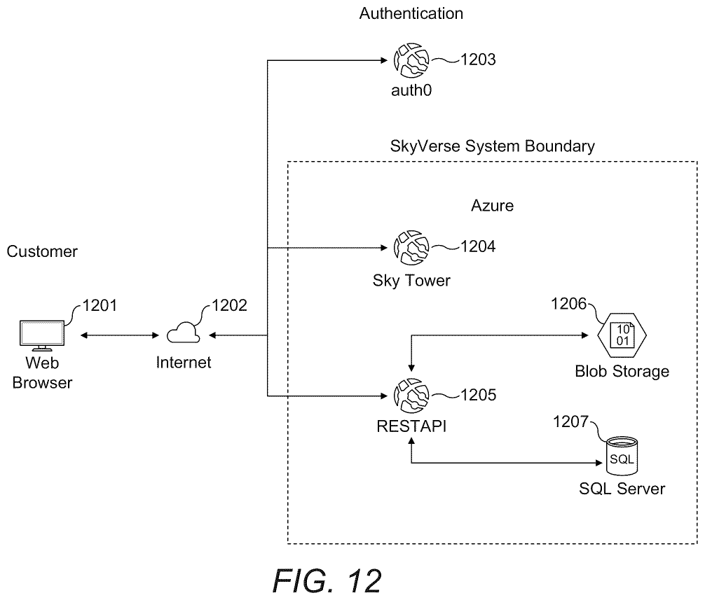

The methods illustrated in FIGS. 10 and 11 may be performed using an electronic flight strip system such as that described below in relation to FIG. 12. In particular, the methods may be implemented by a data processing apparatus comprising a processor configured to carry out the method steps illustrated in FIG. 10 or FIG. 11. The processor may be coupled to the display described in the methods of FIGS. 10 and 11, and it may also be coupled to communication means (such as a network adaptor) that enables communication over a local network and/or the internet. The steps required to perform the methods may also be provided as instructions stored on a computer program product.

FIG. 12 illustrates an exemplary electronic flight strip system apparatus. The apparatus includes a client computing device 1201 (which may also be referred to as a remote display) connected to the internet 1202. The client computing device 1201 can communicate with an authentication server 1203, which may be part of (or in communication with) an electronic flight strip system server 1204. The electronic flight strip system server 1204 is in turn in communication with a data server 1205, which may include object storage 1206 and database storage 1207 and/or other types of storage.

While the authentication server 1203, electronic flight strip system server 1204 and data server 1205 are illustrated as separate components that form part of a distributed system, it should be understood that the authentication server 1203 and/or the data server 1205 could alternatively be combined with the electronic flight strip system server 1204. Each server and the client computing device 1201 comprises a processor, memory and communications interface. They may each further comprise one or more output devices such as displays or speakers etc., and they may also each comprise one or more input devices such as a touchscreen, a mouse, a microphone, a keyboard etc.

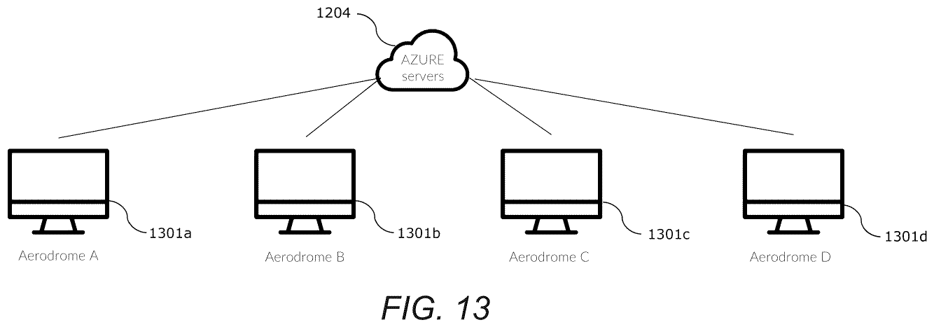

While FIG. 12 illustrates a single client computing device, it is envisaged that the electronic flight strip system may be provided as a cloud-based system that can be accessed by multiple client computing devices. FIG. 13 illustrates such an arrangement, where a plurality of client computing devices 1301a-d are in communication with a plurality of electronic flight strip system servers 1204 (although it should be understood that a single flight strip system server could alternatively be used). In this arrangement, each of the client computing devices 1301a-d may optionally be located at different aerodromes. Alternatively, the electronic flight strip system may be provided as an on-site solution, with the electronic flight strip system server(s) 1204 being on-site (i.e., at the aerodrome) and the client computing devices 1301a-d being located on the same site.

The electronic flight strip system may synchronise modifications made on one client computing device 1301a-d amongst the other client computing devices 1301a-d. For example, instructions to mutate an electronic flight strip may be received from client computing device 1301a. The electronic flight strip system servers 1204 process the instructions, and then serves the other client computing devices 1301b-c with an updated instantiation. Alternatively, the electronic flight strip server may receive a copy of a mutated electronic flight strip from the client computing device 1301a, which it then serves to the other client computing devices 1301a-d. This allows each client computing device 1301a-d store and run a locally-saved instantiation of the electronic flight strip system, which is kept in sync with locally-saved instantiations on other client computing devices 1301a-d.

It is advantageous that the electronic flight strip system is resilient to network failures, such that least basic Air Traffic Control services can be provided if there is communication failure between the client computing devices 1301a-d and the electronic flight strip system servers 1204. In some cases, the client computing devices 1301a-d may be unable to communicate with each other as well as the electronic flight strip system servers 1204. During a communication failure, the electronic flight strip system instantiations on each of the client computing devices 1301a-d may become desynchronised from each other, and/or from the electronic flight strip instantiation on the electronic flight strip system servers 1204.

Accordingly, the electronic flight strip system may designate one of the client computing devices 1301a (or any one of the client computing devices 1301a-d) as the primary offline client computing device. In the event of a communications failure, flight movements are recorded in the local instantiation on the primary offline client computing device 1301a. Flight movements may also be recorded in the local instructions on the other client computing devices 1301b-d. When communications are re-established, the electronic flight strip system servers 1204 receive records of flight movements and or the local instantiations from the client computing devices 1301a-d. The local instantiation from the primary client computing device 1301a is designated the primary local instantiation. The electronic flight strip system servers 1204 compare the other local instantiations against the primary local instantiation. If conflicting flight movement logs are discovered, then an exception is generated. A user can then choose to merge the conflicting movements into the primary local instantiation, or discard them. Alternatively, the local instantiations may be automatically replaced with copies of the primary local instantiation once communications are re-established.

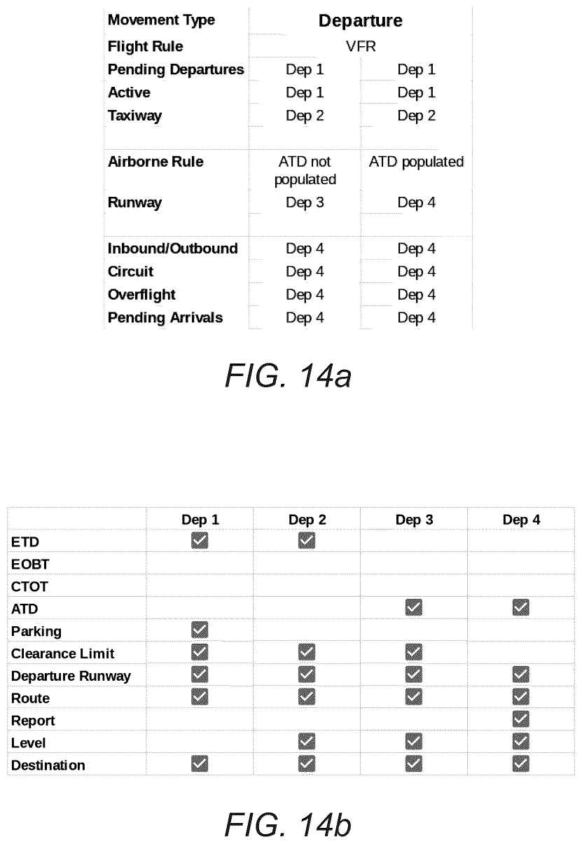

FIGS. 14a and 14b illustrate example rules that may be used by an electronic flight strip system (such as that shown in FIG. 12) to determine which dynamic display fields should be shown on the electronic flight strip 300. In more detail, FIG. 14a shows the rules that apply to Departure Visual Flight Rules (VFR) flights that either do or do not have a populated Actual Time Of Departure (ATD). The table in FIG. 14a has a respective row corresponding to each respective bay of the electronic flight progress board 100 shown in FIG. 1, and each respective row indicates a respective ruleset (Dep 1, Dep 2, Dep 3, or Dep 4) used for an electronic flight strip 300 positioned in that bay.

Exemplary rulesets are shown in the table in FIG. 14b, which indicates which dynamic data fields should be displayed for each ruleset. For example, when the Dep 1 ruleset is selected, the table in FIG. 14b indicates that the fields to be displayed are Estimated Time of Departure (ETD), Parking, Clearance Limit, Departure Runway, Route, and Destination. As shown in FIG. 14a, ruleset Dep 1 applies to Departure Visual Flight Rules (VFR) electronic flight strips positioned in the Pending Departures bay 101b or Active bay 101a.

It should be understood that the rules in FIGS. 14a and 14b are merely illustrative of possible rulesets that could be used, and that different rulesets could be used and rulesets may be adapted to different electronic flight progress board layouts. In addition, it should be understood that similar rules can be created for other types of flights and that similar rules apply for static display fields (although these will be the same for all bays).

While several of the above examples have been given in relation to a particular combination of Flight Movement Types and operating Flight Rules, it should be understood that the underlying principles apply to all combinations of Aircraft Type, Flight Movement Type and Flight Rules etc., and that the display fields and task buttons shown on electronic flight strips in each bay of the electronic flight progress board will be governed by predetermined rules similar to those shown in FIGS. 14a and 14b.

Accordingly, the illustrated electronic flight progress boards, electronic flight strips and rules should be understood to be exemplary only and that other layouts, data fields and rules could be used.

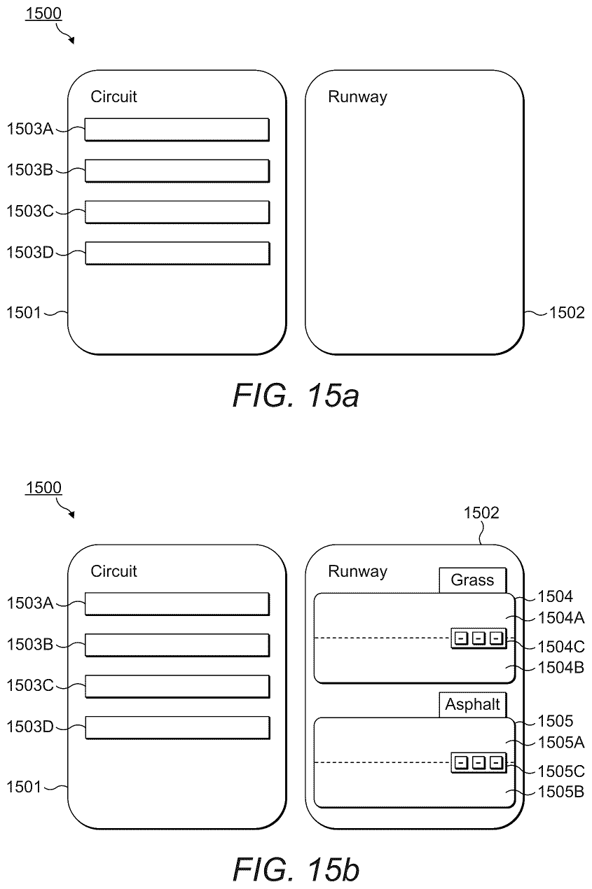

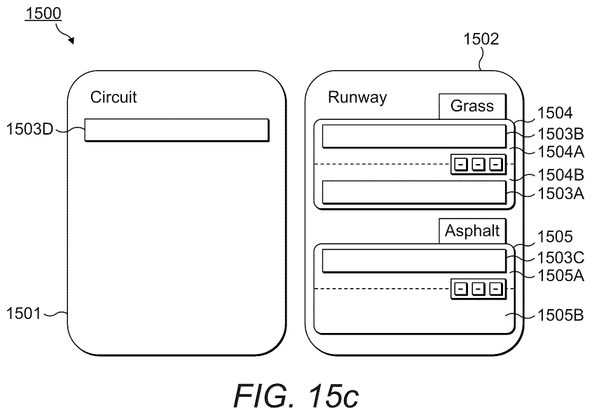

FIG. 15 illustrates how a splitter bay may be used to enhance the functionality of an electronic flight progress board. FIG. 15a illustrates a portion of an electronic flight progress board 1500. The portion includes a first 1501 and second 1502 bay. The first bay 1501 is configured as a Circuit-type bay, for containing flight strips for aircraft circling an aerodrome before final approach. The second bay 1502 is configured as a Runway-type bay, for containing flight strips for aircraft directly on, or approaching, a runway. Four electronic flight strips 1503A-D are positioned in the Circuit bay, representing circling aircraft. The electronic flight strips 1503A-D are successively moved (not shown) onto the Runway bay, as the corresponding aircraft approach and land.

In this example, the electronic flight progress board 1500 represents an aerodrome with a primary asphalt runway, and an additional grass runway. Aircraft prefer to use the smoother asphalt runway, so the grass runway is used only when the asphalt runway is unavailable. In normal flight operations, the runway bay 1502 therefore represents approaches and movement on the asphalt runway. However, when the aerodrome is congested with many aircraft waiting to land, Air Traffic Controllers begin using the additional grass runway.

As shown in FIG. 15b, a user creates a first 1504 and second 1505 splitter bay on the Runway bay 1502. The first splitter bay 1504 represents the asphalt runway, and the second splitter bay 1505 represents the grass runway. The electronic flight strip system may provide instructions for displaying a splitter bay creation dialogue on a display, allowing a user to quickly create and modify a splitter bay 1502, 1503. The splitter bay creation dialogue may function similarly to the electronic flight strip creation dialogue 900 described in relation to FIG. 9. Each splitter bay 1504, 1505 is divided into two sections 1504A/B and 1505A/B. One half 1504A, 1505A of each splitter bay 1504, 1505 represents approaches to a runway, while the other half 1504B, 1505B represents runway occupancy (that is, an aircraft either on or imminently about to be on the runway).

Each splitter bay 1504, 1505 also includes one or more interactive elements 1504C, 1505C in the form of buttons. The interactive elements 1504C, 1505C enable easier mutation of the flight cards placed in the splitter bays 1504, 1505, or the splitter bays 1504, 1505 themselves. The interactive elements 1504C, 1505C may include an “Archive” button for archiving flight strips on the splitter bay, a “Block” button for adding a “Blocked Runway Card” to the Runway bay, and a “Move” button, which moves an electronic flights strip from one section of the splitter bay to another.

FIG. 15c shows electronic flight strips 1503A-D moved into sections A/B of the splitter bays 1504, 1505. For example, electronic flight strip 1503B has been moved into the Approach section 1504A of the asphalt runway splitter bay 1504. When the corresponding aircraft lands on the runway, electronic flight strip 1503B will be moved into the Occupying Runway section 1504B of the asphalt runway splitter bay 1504. If both the Approach 1504A and Occupying Runway 1504B sections of the asphalt runway splitter bay 1504 are full, the electronic flight strip 1504C representing the next approaching aircraft is moved to the Approach section 1505A of the grass runway splitter bay 1505.

The splitter bays 1502, 1503 act in some ways like an electronic flight strip placed in the Runway bay 1502. For example, the splitter bays 1502, 1503 may be sorted within the Runway bay 1502. The splitter bays 1504, 1505 also inherit the rules of their host Runway bay 1502 to determine which dynamic display fields should be shown on the electronic flight strips 1503

Splitter bays enable Air Traffic Controllers to coordinate flight movements across inter-related sections of an aerodrome, such as approaches to a primary and alternate runway. By allowing users to change the functionality of an electronic flight progress board on-the fly (i.e. during active operations), aircraft movements can be handled more efficiently. The user does not need to load an alternate configuration or and can continue controlling or monitoring flight movements.

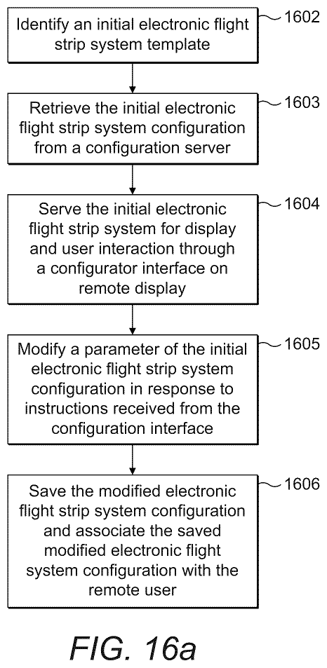

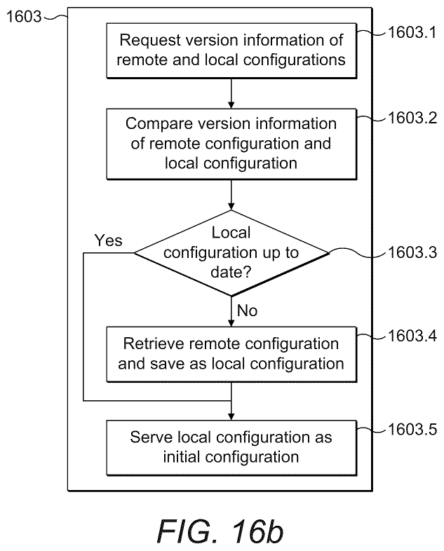

For more significant alterations or to support different aerodrome operations, a user may wish to set up or modify the configuration of an electronic configuration. A method for configuring an electronic flight strip system configuration for an aerodrome will now be described with reference to FIG. 16 (a). The method may be performed over a network.

In some examples, an electronic flight strip configuration may define one or more flight boards; a set of operational values; a set of user permissions, or any combination thereof. An exemplary flight progress board 100 has been previously described in relation to FIG. 1. The configuration may define a flight board by providing instructions for generating and displaying the flight board on a client computing device. A configuration may define a plurality of flight boards. For example, the configuration may comprise flight boards customised for different roles at an aerodrome. These may include an approach board which shows electronic flight strips associated with approaching aircraft, a ground board which shows electronic flight strips associated with aircraft or vehicles on the ground at the aerodrome, or a full board which shows all active electronic flight strips.

One or more of the flight boards may be divided into a number of bays, each bay being associated with a respective type of aircraft location, wherein each bay is configured to display electronic flight strips. The electronic flight strips may have data fields which are determined and populated according to the bay in which the electronic flight strip is located, as previously described. Bays may be associated with a ruleset defining the data fields which are determined and populated for electronic flight strips in that bay.

The set of operational values may define how movements are controlled at a particular aerodrome. The set of operational values may characterise one or more of the: Clearance Limits; Squawks; Approach Types; Airways; Taxi Vias; Approach Positions; Runways; Levels; Clearances; Relative Tos; Vehicle Operations; Service Vehicles; Frequency Transfers; Next Frequencies; Custom Waypoints; VOR Waypoints; IFR Waypoints; VFR Waypoints; Orbit Waypoints; Hold Waypoints; En-route Waypoints; Circuits; Parking, or any combination thereof. A configuration may contain default values for one or more operational values (for example, Squawks), meaning that a user does not need to manually set the values.

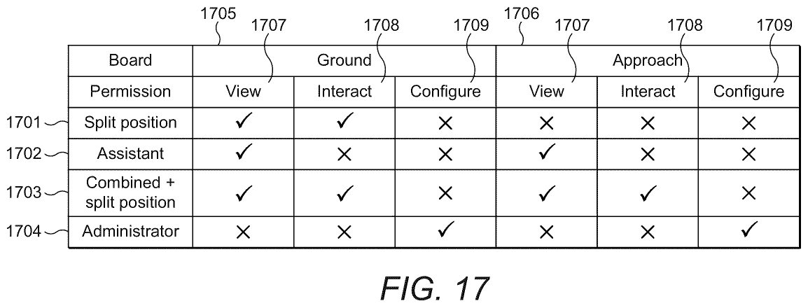

The set of user permissions define the functionality of the electronic flight strip system, depending on the user logging in. The set of user permissions may be determined by the role or roles to be performed by the remote user. In some examples, the remote user logs into an account, and the user permissions define the functionality of the electronic flight strip system or electronic flight strip system instantiation for that account. An example will be explained in reference to FIG. 17.

As previously described, in some examples an electronic flight strip system instantiation may include configuration information. In other words, the configuration may be stored and served as part of the instantiation. In other examples, the configuration may be a separate entity which is associated with particular instantiations. For example, the configuration may define a template board layout, which can be populated with information in order to generate a live instantiation showing up-to-date electronic flight strips in the bays of the board.

In step 1602, an initial electronic flight strip system template is identified by the electronic flight strip system server. The initial template is referred to as such because it has yet to be modified, in contrast to the modified configuration which will be introduced later. If an electronic flight system for an aerodrome is being initialised for the first time, a default template may be used to initialise and generate the initial template. Such templates may be stored on the configuration server, or retrieved from another server when required.

In step 1603, the electronic flight strip system server retrieves the initial template from a configuration server. In some examples, the electronic flight system server also serves as the configuration server, that is, the initial template is stored on the electronic flight system server. In other examples, the initial template is stored on a separate template server, which the electronic flight system server contacts to retrieve the initial template.

Rather than retrieving an initial template, the electronic flight strip system may retrieve a previously-modified configuration associated with the remote user. This allows a user to reconfigure an existing configuration using the configuration interface.

The configuration server may store a set of templates (and/or configurations), wherein each template corresponds to a different set of remote users. In other words, retrieving and serving the initial electronic flight strip system template comprises selecting the initial electronic flight strip system template from a set of initial electronic flight strip system templates stored on the configuration server, wherein each initial flight strip system template is associated with a different set of remote users. In some examples, each of the initial templates may represent a different aerodrome. When a remote user for that aerodrome logs in, the electronic flight strip server retrieves the initial template corresponding to that aerodrome from the configuration server.

In some examples, multiple initial templates may be stored on the configuration server for a given aerodrome or set of remote users, e.g., to be set up as alternate configurations for a particular aerodrome. This allows the electronic flight strip system for that aerodrome to be easily reconfigured. An aerodrome may use one configuration for normal operations, and then retrieve an alternate configuration for special events such as air shows.

The set of initial templates and configurations may be stored within a partitioned document database. Each partition may be dedicated to a specific aerodrome. This allows multiple airport configurations or templates to be stored securely on a single server.

In some examples, the set of operational values (or a subset thereof) is stored separately to the initial template on the configuration server. This allows the set of operational values to be loaded alongside different configurations. For example, an aerodrome may design a primary configuration, and an alternate configuration having different board layouts. The operational values which are defined by the physical layout of the aerodrome, such as those relating to the airways and runways, may be saved to the partition of the configuration server corresponding to the aerodrome. These operational values are then retrieved by the electronic flight strip system server as part of either the primary or alternate configuration.

In some examples, an initial template or configuration comprises a set of aircraft profiles, wherein each profile represents an aircraft. The initial template or configuration may additionally comprise a set of Companies, wherein a Company may own or operate one or more of the aircraft represented by aircraft profiles. Each aircraft profile may include configurable aircraft parameters, such as CallSign, Registration, Aircraft Type, Squawk, Flight Priority Category, Persons On Board, and/or Parking Position. An aircraft profile may be used to populate a new Flight Card representing movements of that aircraft, meaning a user does not need to enter all the aircraft's details. The set of aircraft profiles may include a set of local aircraft profiles, wherein each profile represents an aircraft stationed at the aerodrome. As with the set of operational values, the set of aircraft profiles may be stored separately to the rest of the initial template.

In step 1604, the electronic flight strip system server serves the initial template to a client computing device for display on a display of the client computing device. Once served to the client computing device, the electronic flight strip system server can receive user inputs from the remote user to cause parameters of the initial template to be modified, so as to create an electronic flight strip system configuration.

The initial template is displayed and interacted with by a user through a configuration interface. The configuration interface may be served to the client computing device alongside the initial template, or alternatively the configuration interface may be stored locally on the client computing device, such that the initial template can be loaded into the configuration interface. The configuration interface may allow a user to more easily view, interact with or modify different elements and parameters of the initial template. The configuration interface may display a context menu when a user interacts with an element of the initial template such as a bay, allowing the user to easily perform tasks such as modifying, duplicating or deleting the element. In some examples, the configuration interface may allow a user to select a bay on a flight board layout, and modify parameters of the bay such as its position, size, display name, or type.

The configuration interface may additionally provide premade template elements which can be dragged and dropped into the initial template. For example, the configuration interface may display a set of template bays alongside a flight board layout under modification. A user can add a bay to the flight board layout by selecting a template bay and dragging it onto the flight board layout. Providing template elements allows a user to set up or modify an initial template more easily, as the user does not need to program elements of the initial template from scratch or interact directly with the underlying computer code of the initial template. In some examples, each template bay is provided with a corresponding ruleset. The ruleset may reflect a type of aircraft location or flight movement associated with the bay. For example, a Taxiway-type template bay may be provided with a ruleset which causes electronic flight strips located in the bay to display the departure runway. This allows a user to more easily set up a context-aware flight board.

In step 1605, the electronic flight strip system server modifies one or more parameters of the initial electronic flight strip system template in response to instructions received from the configuration interface, to generate an electronic flight strip system configuration. In some examples, the initial template is transmitted to the client computing device and a local instance of the template is modified by the configuration interface. The electronic flight strip system server then receives the electronic flight strip system configuration from the client computing device, alongside instructions to overwrite, update or otherwise modify the initial template stored on the electronic flight strip system server or configuration server. In other examples, the client computing device does not store an instance of the electronic flight strip system configuration, and the configuration interface functions to record user commands and provide instructions to the electronic flight strip system server to modify the initial template and create the electronic flight strip system configuration.

In some examples, modifying a parameter of the initial template comprises modifying a characteristic of a bay of a flight board layout. One modifiable characteristic of a bay is its presence on a flight board layout. That is, modifying a bay may include adding or deleting the bay from the flight board layout. Modifying a characteristic of a bay may also include modifying a parameter value associated with the bay. A bay may have modified by altering one or more of:
the type of aircraft location associated with the bay (for example, the bay may be changed from a “Runway”-type bay to a “taxiway” type).
the data fields to be determined and populated on electronic flight strips located in the bay. That is, the ruleset provided for the bay may be altered. The electronic flight system server may automatically update the ruleset provided for the bay, when the bay type is changed.
a position of the bay on the flight board layout. This may include the position of the bay within a column. The bay may also be moved from one column to another.
a size of the bay on the flight board layout. In some examples, the size of the bay is static and set manually in the configuration interface. In other examples, the bay size may be dynamic, such that the bay grows to fill the column it is situated in, or sub-divides available space between other bays. In still other examples, the bay may be modified such that its size is based on the number of electronic flight strips located in the bay. The bay may grow and shrink as electronic flight strips are added or removed in use.
a sorting order in which electronic flight strips will be located in the bay. The bay may be configured such that in use, electronic flight strips are sorted such to be displayed in a particular order in the bay. The electronic flight strips may be sorted such that the newest-added or most urgent strips are shown at the top of the bay, or the strips may be sorted by aircraft type. Alternatively another sorting order may be used.
a display name of the bay (e.g., a bay may be configured to display “Terminal 1”, or “Taxiway 2”, etc in the flight board layout).

In some examples, modifying a parameter of the initial template comprises modifying a characteristic of a column of a flight board layout, such as the display name, size, colour or position of the column.

If the initial template has been modified so as to create an electronic flight strip system configuration, then in step 1606 the configuration is saved. The configuration is associated with the remote user, such that the configuration can be retrieved for the remote user at a later date. The configuration may be saved back to the remote configuration server from where the initial template was retrieved. Once saved, the configuration may become the new initial template, and can be retrieved for modification or use by other users. In some examples, version control systems are used to track the changes made to configurations. This allows a user to revert erroneous changes to a modified configuration.

As previously discussed, the electronic flight strip system may retrieve a previously-modified configuration associated with the remote user. Once a user has created an electronic flight strip system configuration from an initial template, the user may store one copy of the configuration locally, and transmit another copy of the configuration to the electronic flight strip system server. It is advantageous to compare and synchronise the remotely stored configuration with the locally stored configuration, to ensure that the remotely stored configuration remains up-to-date with any modifications. An exemplary method for retrieving a configuration is described with reference to FIG. 16 (b). Each configuration has associated version information, such as a version number. The version information may identify the age of the configuration, the modification history of the configuration, and/or the users who have modified the configuration.

Retrieving 1603 the initial configuration includes requesting 1603.1 version information about a remote configuration (that is, a configuration stored on the remote server) and a local configuration (that is, a configuration stored on the local server or device). The configuration information is provided to the electronic flight strip server. The electronic flight strip system compares 1603.2 the version information from the local and remote configurations, and evaluates 1603.3 whether the local configuration is up to date. If the local configuration is not up to date (for example, if another user has made modifications to the remote configuration and saved a new version to the remote server), then the remote configuration is retrieved 1603.4 from the remote server. The remote configuration is then saved 1603.4 to the local device or server as a local configuration. In some examples, the local configuration is overwritten by the locally-saved remote configuration. The locally-saved remote configuration is designated as the local configuration. The local configuration can then be served as the initial template to the client computing device, as per step 1604. Storing a local configuration on the client computing device or local server means that a user can view, interact with or modify a configuration even when the remote server cannot be accessed. The local configuration can also be used to generate instantiations of the electronic flight strip system for live operations, while modifications and tests are run from the remote configuration.

FIG. 17 shows out sets of user permissions associated with a configuration. The configuration comprises two board layouts 1705, 1706. Board layout 1705 is an approach board, and board layout 1706 is a ground movements board. The configuration is associated with a set of roles 1701-1704. A remote user is authorised by the configuration to log in and assume one or more of the roles 1701-1704. Each role 1701-1704 has an associated set of user permissions, laid out in the corresponding rows of the table. The set of user permissions determine the functionality 1707-1708 of each board layout 1705, 1706 for each role 1701-1704. A role may be authorised to view 1707 a flight progress board using a particular board layout. The role may additionally be authorised to interact 1708 with the flight progress board (for example, by moving an electronic flight strip from one bay to another). A role may be authorised to configure 1709 the board layout, for example using the configuration method set out with reference to FIG. 16. As previously described, configuring a board layout may involve changing a characteristic of the board layout, such as a parameter of a bay on the board layout.

A Split Position controller is responsible for controlling one type of aircraft movement at an aerodrome (in this example, ground movement). The Split Position role 1701 is therefore authorised to view 1707 and interact with 1708 instantiations of the Ground flight progress board, which uses the Ground board layout 1705.

For use by controllers undertaking training or at a more junior level, the Assistant role 1702 is authorised to view 1707 both the Ground and Approach flight progress boards, which use the Ground 1705 and Approach 1706 board layouts respectively.

A Combined+Split Position controller may be responsible for many kinds of aircraft movement (in this example, ground and approach movement). The Split Position role 1701 is therefore authorised to view 1707 and interact with 1708 instantiations of both the Ground and Approach flight progress boards, which use the Ground 1705 and Approach 1706 board layouts respectively.

In order to set up or configure 1709 the board layouts 1705, 1706, a user must log into the Administrator role 1704. In this example, the Administrator role 1704 is not authorised to view 1707 or interact with 1708 live instantiations of flight progress boards using the board layouts 1705, 1706. This means that users who are not air traffic controllers can use the Administrator role 1704, without the risk of them inadvertently affecting operation of the aerodrome. The Administrator role 1704 may also be able to modify the set of user permissions for each role—for example, to create a second Split Position user which can view and interact with the Approach board but not the Ground board. The Administrator role may also be able to set which remote users are authorised to log into particular roles.

While the above description generally refers to the electronic flight strip system being operated by an Air Traffic Controller (also known as Air Traffic Control Officers or ATCOs), the system could be operated by any Air Traffic Services operational staff, including Flight Information Service Officers (FISOs).

1.-34. (canceled)

35. A computer implemented method for providing an electronic flight strip system over a network, the method comprising:
receiving and authenticating a remote user login request;
identifying a pre-configured electronic flight strip system instantiation associated with the remote user; and,
serving the pre-configured electronic flight strip system instantiation for display and user interaction on a remote display for managing aircraft movements using electronic flight strips on a digital flight board.

36. A method according to claim 35, wherein the pre-configured electronic flight strip system instantiation is configured by:
serving an initial electronic flight strip system template for display and user interaction through an aerodrome configurator interface;
modifying one or more parameters of the electronic flight strip system template in response to user input received through the configurator interface to create an electronic flight strip system configuration which defines a flight board divided into a number of bays, each bay being associated with a respective type of aircraft location, and electronic flight strips having data fields which are determined and populated according to which bay the electronic flight strip is located; and,
saving the electronic flight strip system configuration as the pre-configured electronic flight strip system instantiation for subsequent use by the remote user.

37. A method according to claim 35, wherein the template defines a set of operational values and a set of user permissions.

38. A method according to claim 37, wherein the set of operational values are preselected from a group comprising: Clearance Limits; Squawks; Approach Types; Airways; Taxi Vias; Approach Positions; Runways; Levels; Clearances; Relative Tos; Vehicle Operations; Service Vehicles; Frequency Transfers; Next Frequencies; Custom Waypoints; VOR Waypoints; IFR Waypoints; VFR Waypoints; Orbit Waypoints; Hold Waypoints; En-route Waypoints; Circuits; and Parking.

39. A method according to claim 35, wherein the bays of the flight board are selected from a group of bays comprising: Pending Departures, Active, Taxiway, Runway, Inbound/Outbound, Circuit, Overflight, Pending Arrivals.

40. A method according to claim 35, further comprising receiving and storing a mutated electronic flight strip from a remote device corresponding to the remote user.

41. A method according to claim 35, further comprising receiving movement logs of an electronic flight strip from a first bay to a second bay and storing an updated electronic flight strip in memory.

42. A method according claim 35, wherein the preconfigured electronic flight strip system instantiation defines a set of rules for aircraft movements against which a detected user input on the remote display is validated, and the method further comprises providing instructions to generate an exception if an invalid aircraft movement is detected.

43. A method according to claim 35, further comprising serving the pre-configured electronic flight strip system instantiation electronic flight strip system instantiation for display and user interaction on a different display.

44. A method according to claim 35, performed over a network from a cloud-based computing resource coupled to an aerodrome operating one or more displays for provision of Air Traffic Services.

45. A method according to claim 35, further comprising maintaining a stored digital record for electronic flight strips representing aircraft movements over time.

46. A method according to claim 45, further comprising: receiving a query requesting a subset of the stored digital record from the remote user; processing the stored digital record in response to the query to extract the requested subset; and, serving the requested subset to a remote device corresponding to the remote user.

47. A method according to claim 35, further comprising providing instructions for displaying a flight creation dialogue on the display, wherein the flight creation dialogue comprises a plurality of data entry fields, wherein the plurality of data entry fields comprises a subset of data entry fields configured from a set of data entry fields, and wherein the plurality of data entry fields is selected from the set of data entry fields based on a Flight Movement Type input by the user.

48. A method according to claim 35, wherein serving a pre-configured electronic flight strip system instantiation comprises selecting the pre-configured electronic flight strip system instantiation from a plurality of pre-configured electronic flight strip system instantiations, wherein each pre-configured electronic flight strip system instantiations is associated with a different set of remote users.

49. A method according to claim 35, wherein the electronic flight strip system instantiation includes configuration information, the configuration information including a set of user permissions, and the method further comprises adapting the pre-configured electronic flight strip instantiation for the remote user according to the set of user permissions.

50. A computer implemented method for configuring an electronic flight strip system configuration over a network, the method comprising:
receiving and authenticating a remote user login request;
serving an initial electronic flight strip system template for display and user interaction through a configurator interface on a remote display;
modifying a parameter of the initial electronic flight strip system template in response to instructions received from the configuration interface to create an electronic flight strip system configuration which defines a flight board divided into a number of bays, each bay being associated with a respective type of aircraft location, and electronic flight strips having data fields which are determined and populated according to which bay the electronic flight strip is located; and,
saving the modified electronic flight strip system configuration and associating the saved modified electronic flight system configuration with a remote user.

51. A method according to claim 50, wherein the one or more flight board layouts are each divided into a number of bays, each bay being associated with a respective type of aircraft location, wherein each bay is configured to display electronic flight strips, each electronic flight strip having data fields which are determined and populated according to which bay the electronic flight strip is located, and wherein modifying a parameter of the initial electronic flight system template comprises modifying a characteristic of a bay of a flight board layout, and wherein the modifiable characteristics of a bay modify one or more of:
the type of aircraft location associated with the bay;
the data fields to be determined and populated on electronic flight strips located in the bay;
a position of the bay on the flight board layout;
a size of the bay on the flight board layout;
a sorting order in which electronic flight strips will be located in the bay; and,
a display name of the bay.

52. A method according to claim 50, wherein modifying a parameter of the initial electronic flight system template comprises selecting a bay for the flight board layout from a pre-configured set of bay templates.

53. A method according to claim 50, wherein serving the initial electronic flight strip system configuration comprises selecting the initial electronic flight strip system template from a set of initial electronic flight strip system templates stored on the configuration server, wherein each initial electronic flight strip system template is associated with a different set of remote users.

54. The method according to claim 53, wherein each set of remote users corresponds to a different set of aerodromes.
